(19) United States
(12) Patent Application Publication
(10) Pub. No.: US 2026/0119031 A1
(43) Pub. Date: Apr. 30, 2026

(54) STORAGE OPTIMIZATION

(71) Applicant: Mellanox Technologies Ltd., Yokneam (IL)

(72) Inventors: Gil Shabat, Hod Hasharon (IL); Itay Alroy, Nes Ziona (IL); Shlomi Nimrodi, Ramat Gan (IL); Hanan Shteingart, Herzliya (IL); Shai Malin, Tel Aviv (IL); Shie Mannor, Haifa (IL); Gilad Saban, Rehovot (IL)

(73) Assignee: Mellanox Technologies Ltd., Yokneam (IL)

(21) Appl. No.: 18/928,276

(22) Filed: Oct. 28, 2024

(51) Int. Cl. G06F 3/06; G06N 7/01

(52) U.S. Cl. CPC G06F 3/0604; G06F 3/0653; G06F 3/0679; G06N 7/01

(57) ABSTRACT

A system and method for improving performance of a storage system, including, using a computer processor: measuring at least one performance indicator of the storage system, while performing input and/or output operations to the storage system; using an optimization scheme, changing a plurality of configuration parameters of the storage system; and repeating changing and measuring until a stopping criterion is met.

### FIELD OF THE INVENTION

The present invention relates generally to improving the performance of storage systems using artificial intelligence (AI).

### BACKGROUND

Modern computer data storage systems may include networked storage, e.g., storage devices that are remote to the host. The host may access the remote storage through a network, e.g., the Internet. Some systems may implement storage virtualization, where an emulator may present the networked storage as a local block-storage device (e.g., a solid-state drive, SSD) to the host. In this case, the operating system (OS) of the host may use its standard storage driver to perform read and write operations, also referred to as input and output (I/O) operations, unaware that communication is done, not with a physical drive, but with the emulator.

Both local or remote block-storage devices may include several physical and/or virtual disks and the performance of either local or remote block-storage devices may depend greatly on configuration parameters of the block-storage devices.

### SUMMARY

According to embodiments of the invention, a computer-based system and method for improving performance of a storage system may include, using a computer processor: measuring at least one performance indicator of the storage system, while performing input and/or output operations to the storage system; using an optimization scheme, changing a plurality of configuration parameters of the storage system; and repeating changing and measuring until a stopping criterion is met.

According to embodiments of the invention, the optimization scheme may be Bayesian optimization.

According to embodiments of the invention, the optimization scheme may be reinforcement learning.

According to embodiments of the invention, the storage system may include at least one remote storage system, and an emulator connected to a host and to the remote storage system, wherein the emulator is configured to emulate the remote storage system to appear as a local disk to the host.

According to embodiments of the invention, each of the plurality of configuration parameters may be selected from: a block size, a number of the remote storage systems and speed of the remote storage systems.

According to embodiments of the invention, each of the at least one performance indicator may be selected from input and output operations speed, a measure of fairness, latency and throughput.

According to embodiments of the invention, the stopping criterion may be that the at least one performance indicator reach a steady state.

According to embodiments of the invention, the stopping criterion may be that a predetermined number of iterations have been performed.

### BRIEF DESCRIPTION OF THE DRAWINGS

Non-limiting examples of embodiments of the disclosure are described below with reference to figures attached hereto that are listed following this paragraph. Dimensions of features shown in the figures are chosen for convenience and clarity of presentation and are not necessarily shown to scale.

The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanying drawings. Embodiments of the invention are illustrated by way of example and not limitation in the figures of the accompanying drawings, in which like reference numerals indicate corresponding, analogous or similar elements, and in which:

FIG. 1 illustrates a high-level block diagram of an exemplary computing device with local storage, according to embodiments of the present invention.

FIG. 2 illustrates a high-level schematic diagram of a network interface card, according to embodiment of the invention.

FIG. 3 illustrates experimental results of an optimization process of configuration parameters of a remote storage system, according to embodiments of the invention.

FIG. 4 illustrates a flowchart of a method for improving performance of a storage system, according to embodiments of the present invention.

FIG. 5 illustrates a system according to at least one example embodiment.

FIG. 6 illustrates an example data center, in which at least one embodiment may be used.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

Embodiments of the invention may provide a system and method for optimizing the performance of a computer data storage system automatically. State of the art storage systems may include local and/or remote storage devices employing a plurality of physical and virtual disks. Such storage systems may be sensitive to settings of configuration parameters, where minor modifications in the configuration parameters may make a significant difference in performance, and it may be hard to predict what values of the configuration parameters may provide better performance in which scenario.

Embodiments of the invention may start the optimization process with a list of suggested or preset configuration sets or an initial guess of configuration parameters of the storage system, measure performance indicators of the storage system while working with those configuration parameters, and use an AI optimization scheme such as Bayesian optimization or reinforcement learning (RL) to select a new set of the configuration parameters. An embodiment may continue to change configuration parameters and measure performance indicators until the performance is optimized (e.g., maximizing or minimizing an objective). The storage system may include a local storage device and/or a remote storage system that is emulated to appear as a local disk to the host. The configuration parameters may include one or more of block size, number of remote storage systems and speed of the remote storage systems, etc. The performance indicators may include one or more of a measure of input and output operations speed (e.g., IOPs), latency, throughput, a measure of fairness, etc.

Bayesian optimization may include an approach to optimizing an objective function. An embodiment using Bayesian optimization may build a surrogate model for the objective function, quantify the uncertainty in that surrogate model using a Bayesian machine learning technique, and then use an acquisition function defined from this surrogate model to decide on the next parameter values, e.g., the next parameter values of choice are where the acquisition function is maximized. Bayesian optimization may improve the search speed compared with random search by using past performances of previous parameter values for setting new parameter values. Reinforcement learning may refer to an ML technique that trains software to take a suitable action to maximize reward in a particular situation by using an algorithm that learns from outcomes (e.g., feedback) and decides which action to take next. Other optimization algorithms may be used.

Embodiments of the invention may improve the performance of the computer itself and the technology of computer storage systems by improving the performance of storage systems. Embodiments of the invention may provide the ability to change a wide set of configurations parameters and test the influence of this change on the performance of the storage system. Utilizing an optimization scheme that may intelligently (e.g., using artificial intelligence optimization schemes) search for the best (or nearly the best) combination of configuration parameters may significantly improve the performance of the storage system compared to a default setting. Furthermore, using AI optimization schemes such as Bayesian optimization or reinforcement learning may optimize a storage system using small number of iterations instead of exploring huge number of combinations, thus providing significant improvement of the storage system in reasonable time and using relatively low computational resources.

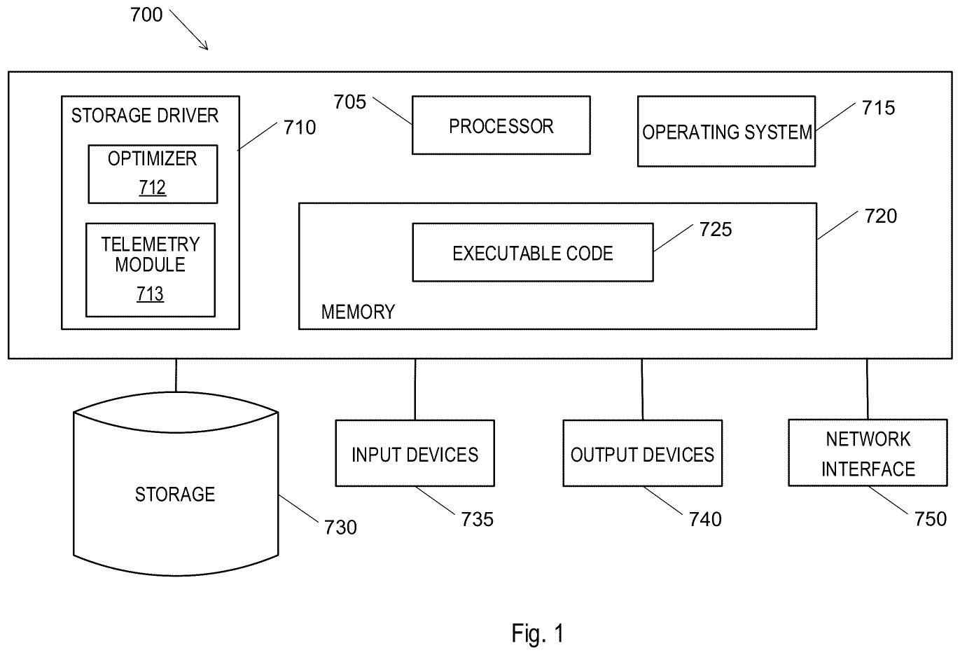

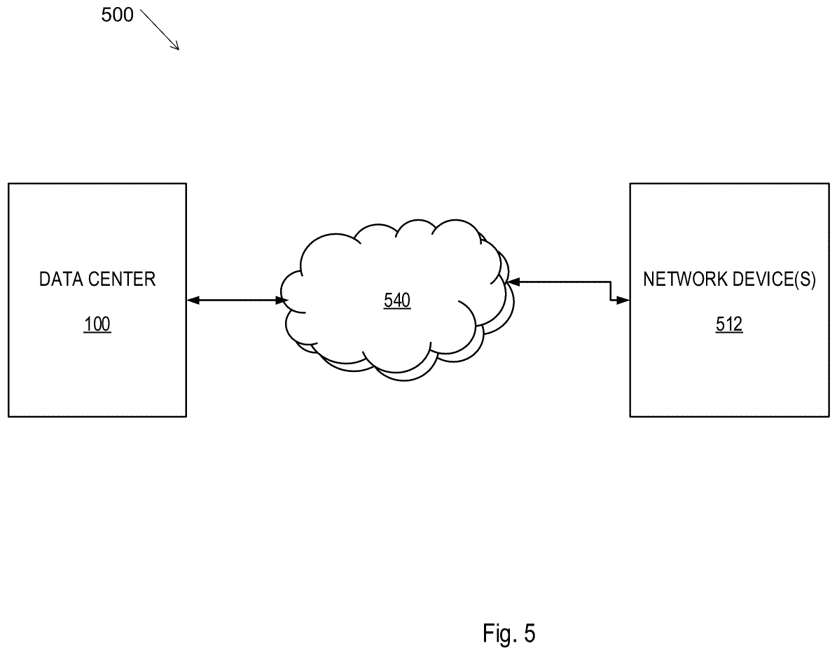

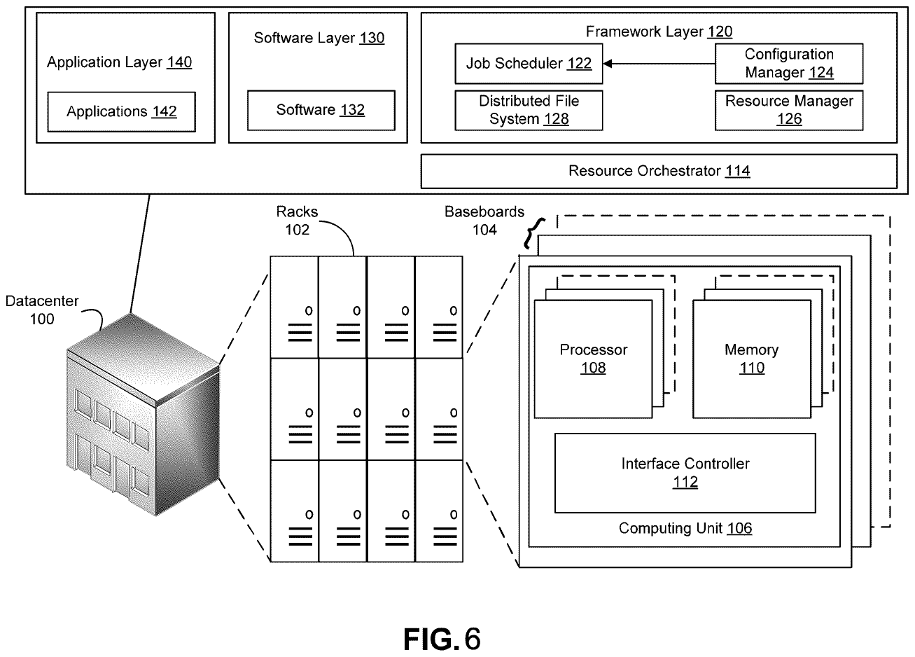

FIG. 1 illustrates a high-level block diagram of an exemplary computing device 700 with local storage 730, according to embodiments of the present invention. According to embodiments of the invention, computing device 700 may be implemented within the framework of or a part of a data center, e.g., data center 100 depicted in FIGS. 5 and 6. Computing device 700 may include a controller or processor 705, that may be or include, for example, one or more central processing unit processor(s) (CPU), one or more graphics processing unit(s) (GPU), a one or more data processing unit(s) (DPU), a chip or any suitable computing or computational device, an operating system (OS) 715, a memory 720, local storage 730, input devices 735 and output devices 740. In some embodiments, a host processor or host of system 700 may be or may include processor 705.

Operating system 715 may be or may include any code segment designed and/or configured to perform tasks involving coordination, scheduling, supervising, controlling or otherwise managing operation of computing device 700, for example, scheduling execution of programs. Memory 720 may be or may include, for example, a random access memory (RAM), a read only memory (ROM), a dynamic RAM (DRAM), a volatile memory, a non-volatile memory, a cache memory, or other suitable memory units or storage units. Memory 720 may be or may include a plurality of possibly different memory units. Memory 720 may store for example, instructions to carry out a method (e.g. code 725), and/or data such as configuration parameters, etc.

Executable code 725 may be any executable code, e.g., an application, a program, a process, task or script. Executable code 725 may be executed by processor 705 possibly under control of operating system 715. For example, executable code 725 may, when executed, carry out methods according to embodiments of the present invention. For the various modules and functions described herein, one or more computing devices 700 or components of computing device 700 may be used. One or more processor(s) 705 may be configured to carry out embodiments of the present invention by, for example, executing software or code.

Storage 730 may be or may include, for example, a hard disk drive, a floppy disk drive, a Compact Disk (CD) drive, or other suitable removable and/or fixed storage unit. Data such as instructions, code, etc. may be stored in storage 730 and may be loaded from storage 730 into a memory 720 where it may be processed by processor 705. Some of the components shown in FIG. 1 may be omitted.

Input devices 735 may be or may include for example a mouse, a keyboard, a touch screen or pad or any suitable input device. Any suitable number of input devices may be operatively connected to computing device 700 as shown by block 735. Output devices 740 may include displays, speakers and/or any other suitable output devices. Any suitable number of output devices may be operatively connected to computing device 700 as shown by block 740. Any applicable input/output (I/O) devices may be connected to computing device 700, for example, a modem, printer or facsimile machine, a universal serial bus (USB) device or external hard drive may be included in input devices 735 or output devices 740. Network interface 750 may enable device 700 to communicate with one or more other computers or networks. For example, network interface 750 may include a wired or wireless NIC.

Embodiments of the invention may include one or more article(s) (e.g. memory 720 or storage 730) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

Local storage 730 may include a plurality of physical computer storage disks and/or a plurality of virtual disks. Achieving best or improved performance local storage 730, compared with an initial setting of local storage 730, may require tuning a relatively large number of configuration parameters. Those configuration parameters may include, for example:
1. block size
2. number of storage systems
3. speed of the storage systems
4. poll_size—Maximal number of IOs to progress per poll cycle, (integer [1, 256])
5. poll_ratio—The rate in which poll cycles occur, (float [0,1])
6. max_inflights—Maximal number of inflight IOs per core, (integer [1, 2\hat{ }16])
7. max_iog_batch—Maximum fairness batch size, e.g., how many IOs to poll from a specific block device before moving to the next one, (integer [1, 2\hat{ }13])
8. max_new_ios—Maximum number of new IOs to handle in a single poll cycle (integer [1, 2\hat{ }13])

It is noted that the above list is provided as an example only, and the tuned parameters may depend on the specific storage system that is being optimized. In some implementations, other parameters may be used, or some of the above-listed parameters may be given by the system and may not be tuned.

Parameters 4-8 may relate to NVIDIA® BlueField® SNAP (storage-defined network accelerated processing) and virtio-blk SNAP technology, which may be a polling application. SNAP may handle a plurality of queues, and poll the queues to get new I/Os and handle them. Each time SNAP gets CPU time, it may poll some queues and then yield so other applications (such as transport applications, etc.) can also progress their pending I/Os. The time between the wake-up and the yield is referred to herein as the polling cycle. Parameters 4-8 may be guidelines to SNAP as to how to behave during the poll cycle. For example, max_new_ios determines the maximum number of I/Os to be polled in a single poll cycle, etc. The max_inflights parameter may limit the total number of I/Os that SNAP can have outstanding, meaning once max_inflights outstanding I/Os are handled, any additional I/O may not be handled until some of the existing ones are finished.

Thus, optimizing the configuration parameters may be defined as a high-dimension optimization problem. For example, the number of combinations of parameters 4-8 listed above is huge, about 10\hat{ }18. While the number of combinations may be reduced using empirical methods to about 20 million, this may still be a huge search space. Thus, searching linearly for an optimized combination of parameters, where each iteration of search requires setting a set of configuration parameters and measuring the resultant performance parameters, may be a computationally intensive task that may be costly in terms of computer power and time. Changes to the configuration parameters such as the block size that is used by the processor 705 or number or speed of available local storage systems 730 may reduce or increase the general performance of storage system 730, e.g., may change one or more performance indicators such as the measured in I/O's per second, the throughput, latency, fairness etc. I/O's per second may be the number of input and output (e.g., read and write) operations to and from storage device 730 per second. Throughput may refer to the rate at which data can be read from or written to memory and is typically measured in bytes per second. Latency may refer to the time I/O's take to complete. Fairness is a measure of how the bandwidth of storage device 730 is divided between a plurality of hosts or tasks.

According to embodiments of the invention, storage driver 710 may utilize a machine learning (ML) solution, that may include ML optimization tools such as Bayesian optimization and/or reinforcement learning, that may automatically tune the configuration parameters of storage system 730 to find the best performance efficiently.

Storage driver 710 may include an optimizer 712 and a telemetry module 713, configured to perform embodiments of the invention. Specifically, optimizer 712 may use an ML optimization scheme such as Bayesian optimization or reinforcement learning to select a set of the configuration parameters for local storage 730, and telemetry module 713 may measure performance indicators of local storage 730, as disclosed herein. Telemetry module 713 may measure performance indicators of local storage 730 in any applicable manner.

Storage driver 710, optimizer 712 and a telemetry module 713 may be or may include any combination of software and hardware modules, e.g., software executed by processor 705 (e.g., by the same processor or different processor to the host) and/or by dedicated hardware or a chip, etc.

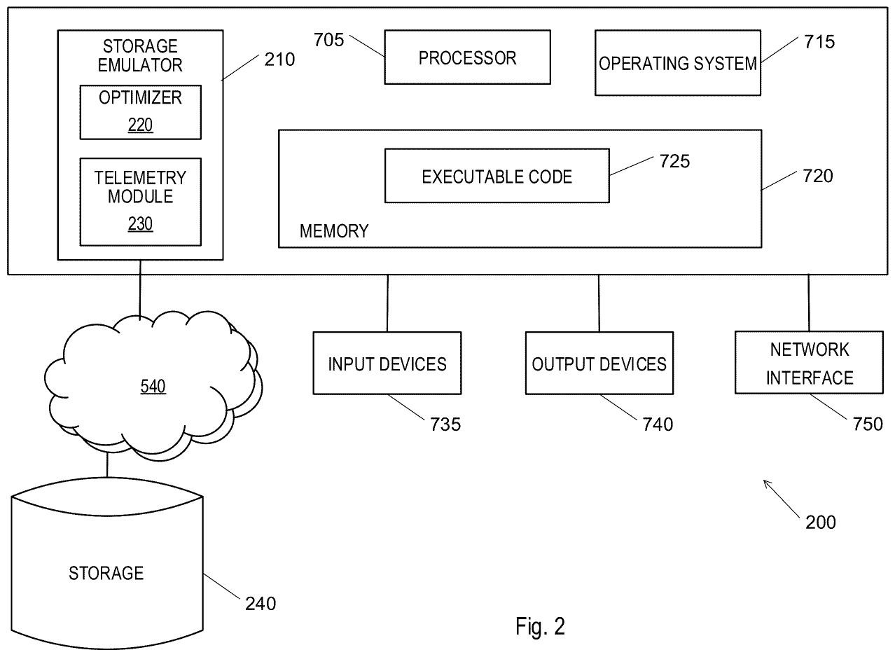

FIG. 2 illustrates a high-level block diagram of an exemplary computing device 200 with remote storage 240, according to embodiments of the present invention. According to embodiments of the invention, computing device 200 may be implemented within the framework of or a part of a data center, e.g., data center 100 depicted in FIGS. 5 and 6. Computing device 200 may be similar to computing device 700, except for having a remote storage 240 instead of or in addition to local storage 730. Computing device 200 may access remote storage 240 over network 540. While drawn as two separate systems, it is noted that a single computing device may include both local storage 730 and remote storage 240, and associated storage driver 710 and/or storage emulator 210.

Networks 540 may include any type of computer network or combination of networks available for supporting communication between processor 705 and remote storage 240. Networks 540 may include for example, a wired, wireless, fiber optic, or any other type of connection, a local area network (LAN), a wide area network (WAN), the Internet and intranet networks, etc.

Computing device 200 may include storage emulator 210, that may include optimizer module 220 and telemetry module 230. Storage emulator 210 optimizer module 220 and telemetry module 230 may be or may include any combination of software and hardware modules, e.g., software executed by processor 705 (e.g., by the same processor or different processor to the host) and/or by dedicated hardware or a chip, etc.

Remote storage 240 may include a plurality of physical disks and/or a plurality of virtual disks. Achieving best or improved performance of remote storage 240, compared with an initial setting of remote storage 240, may require tuning a relatively large number of configuration parameters. Those configuration parameters may configuration parameters 1-8 listed above and/or other parameters. Thus, optimizing the configuration parameters may be defined as a high dimension optimization problem. Changes to the configuration parameters such as the block size that is used by the host 705 or number or speed of available remote storage systems 240 may reduce or increase the general performance of remote storage systems 240, e.g., may change one or more performance indicators such as the measured in I/O's per second, the throughput, latency, fairness, etc. According to embodiments of the invention, storage emulator 210 may utilize an ML solution, that may include ML optimization tools such as Bayesian optimization and/or reinforcement learning, that may automatically tune the configuration parameters of remote storage systems 240 to find the best performance efficiently.

Storage emulator 210 may be connected to host processor 705 and to remote storage system 240, and may emulate remote storage systems 240 to appear as a local disk to host processor 705. In some embodiments, storage emulator 210 may include NVIDIA® BlueField® SNAP and virtio-blk SNAP technology, that may enable hardware-accelerated virtualization of local storage. NVMe/virtio-blk SNAP may present remote storage system 240 as a local block-storage device (e.g., SSD) emulating a local drive on a peripheral component interconnect express (PCIe or PCI-E) bus (not shown) of system 700. OS 715 may use its standard storage driver, unaware that communication is performed, not with a physical drive, but rather with NVMe/virtio-blk SNAP framework. OS 715 may issue I/O requests to the nonvolatile memory express (NVMe)/virtio-blk SNAP storage access and transport protocol that may be redirected to remote storage 240 or local storage 730. Other storage emulators 210 may be used.

Storage emulator 210 may further include an optimizer 220 and a telemetry module 230, configured to perform embodiments of the invention. Specifically, telemetry module 230, may measure performance indicators of remote storage systems 240 while (e.g. substantially concurrently, or at an overlapping time) processor 705 is performing input and/or output (IO's) operations to remote storage system 240, and optimizer 220 may use an ML optimization scheme such as Bayesian optimization or reinforcement learning to dynamically change the set of the configuration parameters for remote storage system 240, as disclosed herein. Telemetry module 230 may continue measuring the performance indicators and optimizer 220 may repeat or iterate changing the set of the configuration parameters until a stopping criterion is met, e.g., until an objective of the optimization scheme is maximized or minimized and/or one or more performance indicators stabilize or reach a steady state. The objective may include reaching a stable level of one or more of the performance indicators or reaching a predefined number of iterations.

Telemetry module 230 may measure performance indicators of remote storage systems 240 in any applicable manner, either locally at computing device 200 or remotely at storage device 240. The performance indicators may be for example one or more of a measure of input and output operations speed, throughput, latency and a measure of fairness, but not limited to these performance indicators. Since some of the measurements of the performance indicators may be noisy, telemetry module 713 or 230 may filter the measurement results using s lowpass filter or use statistics such as mean or median over a time window to obtain the values of the performance indicators.

Optimizer 712 or 220 may use an ML optimization scheme such as Bayesian optimization or reinforcement learning to dynamically change the set of the configuration parameters for remote storage systems 730 or 240. Bayesian optimization may include an approach or a strategy to find the global optimum of a black box function ƒ that maps a vector (e.g., a list of values) [symbol] to a result [symbol] , ƒ: [symbol] Here, the list of values may include the plurality of configuration parameters, and the result is the one or more performance indicators.

To implement reinforcement learning, systems 700 or 200 may sample ƒ at random or pseudo-random initial n points, where n is a positive integer. For sampling a single point of ƒ both the plurality of configuration parameters and the resultant one or more performance indicators may be sampled. For example, optimizer 712 or 220 may select random or pseudo random sets of values for the plurality of configuration parameters. For each set of values of the plurality of configuration parameters, systems 700 or 200 may take a measurement of function ƒ, e.g., processor 705 may perform a plurality of input and/or output operations to storage system 730 or 240 using the values selected for the plurality of configuration parameters, and telemetry module 713 or 230 may measure the resultant one or more performance indicators. Thus, each sample of function ƒ may include a set of configuration parameters and the resultant one or more performance indicators. After sampling the initial n points of function ƒ, optimizer 712 or 220 may build a surrogate model based on the initial n points and set the hyperparameters of the surrogate model to maximize the likelihood. The surrogate model may include a Gaussian process, that may estimate the expected value of the one or more performance indicators and the uncertainty level of those values at the unknown points. A kernel of the Gaussian process may be used to incorporate external knowledge and handle noisy observations. Based on the surrogate model, telemetry module 713 or 230 may choose or select the next point to sample, e.g., the next values for the plurality of configuration parameters. Telemetry module 713 or 230 may select or choose the next values for the plurality of configuration parameters by deriving an acquisition function from the surrogate model, and using the acquisition function to choose or select the next values for the plurality of configuration parameters. The acquisition function may combine between exploration and exploitation, considering the expected value and the uncertainty, e.g., the acquisition function may try to predict the value for a new configuration and the uncertainty. The trade between exploration and exploitation may include choosing between giving priority for sampling from high priority areas or from low uncertainty areas. After selecting or choosing the next values for the plurality of configuration parameters, systems 700 or 200 may take a measurement of function ƒ, e.g., e.g., processor 705 may perform a plurality of input and/or output operations to storage system 730 or 240 using the values selected for the plurality of configuration parameters, and telemetry module 713 or 230 may measure the resultant one or more performance indicators. Telemetry module 713 or 230 may repeat building the surrogate model, this time with all the previous points of function ƒ and the new point of function ƒ, and choose or select the next point to sample and so forth, until a stopping criterion is met. The stopping criterion may be a number of iterations, e.g. the process may stop when a number of iterations is reached, and the set of configuration parameters that provided the best performance indicators may be selected or chosen as the configuration parameters to be used by systems 700 or 200. Other stopping criteria may be used, e.g., the process may stop after the value of the performance indicators stabilizes or reaches a steady state.

Reinforcement learning may be a machine learning paradigm, where an agent may learn to make sequential decisions by interacting with an environment. The agent receives feedback in the form of rewards or penalties, and its goal is to maximize the cumulative reward over time. In essence, reinforcement learning is about learning through trial and error. When applied to optimization problems, the optimization problem is framed as an environment, and the possible solutions may include the actions the agent can take. The agent may explore different solutions, and the rewards the agent receives may guide the agent towards the optimal solution. The goal of the agent is to find a policy that maximizes the reward.

According to embodiments of the invention, the environment may include the configuration parameters and the reward may include the performance indicators. Thus, optimizer 712 or 220 may select an initial set of performance indicators as the initial guess, processor 705 may perform a plurality of input and/or output operations to storage system 730 or 240 using the initial guess of the plurality of configuration parameters, and telemetry module 713 or 230 may measure the resultant one or more performance indicators which are the reword. In following iterations, the rewards, e.g., the measured one or more performance indicators, that optimizer 712 or 220 receives, may guide optimizer 712 or 220 towards the optimal solution. Again, the process may repeat until a stopping criterion is met, similarly to using reinforcement learning. Other optimization schemes may be used.

Once the configuration parameters are selected or chosen using any optimization scheme, system 700 may continue using those configuration parameters for configuring storage driver 710 or 210 and storage systems 730 or 240.

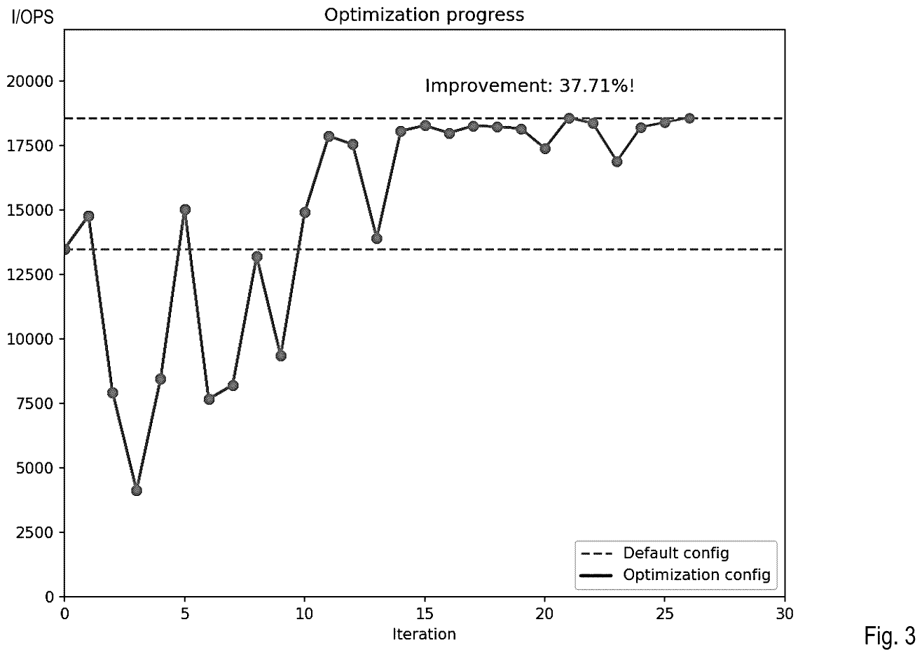

Reference is now made to FIG. 3 which illustrates experimental results of an optimization process of configuration parameters of a remote storage system, according to embodiments of the invention. The test included applying the algorithm to real hardware, in order to find the best configuration. Once this configuration was found, the parameters were set to this configuration and the number of I/OPs was measured. The test setup included an NVIDIA BlueField-3 DPU (BF3), which is a 400 gigabits per second (Gb/s) infrastructure compute platform, connected to a hypervisor and two remote storage servers. The BF3 exposed 250 NVMe (nonvolatile memory express) devices to the hypervisor. The hypervisor sent random I/Os toward the NVMe devices, which the BF3 redirected to the remote storage servers (over RDMA/TCP transports) and vice versa.

As can be seen, in one implementation, the I/O operations per second (I/OPS) increased by 37.71% after optimization. In each iteration, the Bayesian optimization steps are applied, and a new point is measured, until getting the optimal solution. Stopping criteria can be number of iterations or until reaching a stable value.

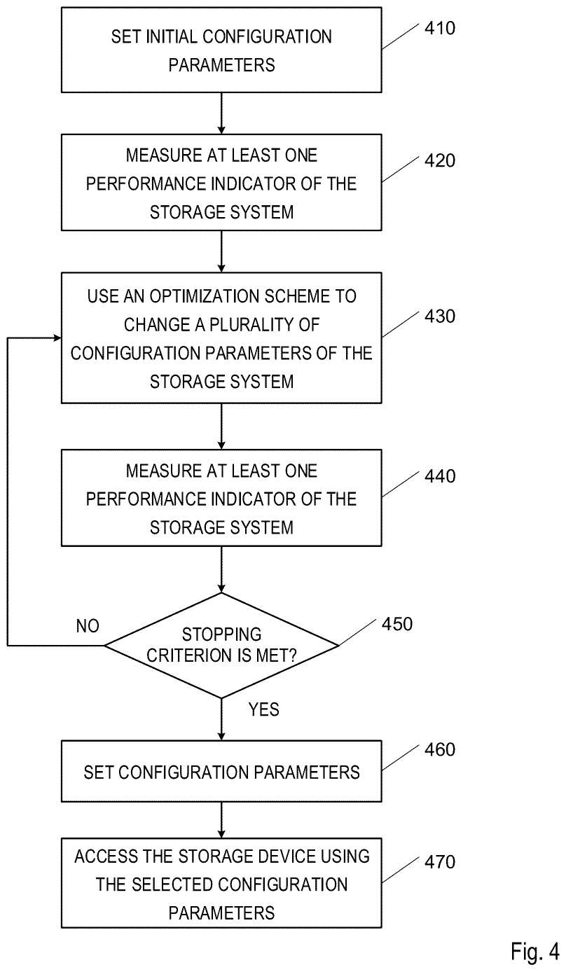

Reference is now made to FIG. 4, which illustrates a flowchart of a method for improving performance of a storage system, according to embodiments of the invention. While in some embodiments the operations of FIG. 4 are carried out using systems as shown in FIGS. 1 and 2, in other embodiments other systems and equipment can be used.

In operation 410, a processor (e.g., processor 705 depicted in FIGS. 1 and 2) may set initial configuration parameters of a storage system, e.g., local storage 730 or remote storage 240. For example, the processor may randomly guess the initial configuration parameters or obtain default or factory values. In operation 420, the processor may measure at least one performance indicator of the storage system. The measurement may be performed in any applicable manner, while the processor is performing input and/or output operations to the storage system. In operation 430, the processor may use an optimization scheme to change a plurality of configuration parameters of the storage system. The optimization scheme or algorithm may use the results of previous measurements of the performance indicators to set new values for the configuration parameters. For example, Bayesian optimization or reinforcement learning optimization algorithms may be used. Other optimization schemes or algorithms may be used. In operation 440, the processor may measure at least one performance indicator of the storage system, similarly to operation 420. In operation 440, the processor may evaluate whether a stopping criterion is met. The stopping criterion may be that the at least one performance indicator reach a steady state or that a certain number of iterations is reached. If the stopping criterion is not met, the processor may go back to operation 430, to repeat changing the configuration parameters and measuring the performance indicators, until the stopping criterion is met. Each repetition of operations 430-450 may be referred to herein as an iteration. Once the stopping criterion is met, the processor may select the optimal configuration parameters in operation 460. In operation 470, the processor may use the configuration parameters selected in operating 460, e.g., the processor may access or perform I/O operations to the storage device using the selected configuration parameters.

FIG. 5 illustrates a system 500 according to at least one example embodiment. System 500 may include a data center 100, a communication network 540, and one or more network devices 512.

Data center(s) 100 may be the storage and data processing hubs of the internet. The massive deployment of cloud applications is causing data centers 100 to expand exponentially in size, stimulating the development of faster switches than can cope with the increasing data traffic inside the data center. Current state-of-the-art switches are capable of handling 12.8 Tb/s of traffic by employing electrical switches in the form of application specific integrated circuits (ASICs) equipped with 256 data lanes, each operating at 50 Gb/s. Such switching ASICs typically consume as much as 400 W, and the power consumption of the optical transceiver interfaces attached to each ASIC is comparable.

Data center(s) 100 may include multiple network switches in a particular topology, such as a fat tree topology, a slim fly topology, a dragonfly topology, and/or the like. The specifications and makeup of the network switches in the topology affects the overall network performance (e.g., bandwidth capability) of data center 100.

Data center 100 may be a centralized facility designed to house computing resources and related components. The primary function of data center 100 may be to support the infrastructure required for advanced computational tasks, for efficient, secure, and reliable operations. Data center 100 may include building and structural components, including power supplies, cooling systems, fire suppression systems, and physical security measures that are configured to maintain optimal operating conditions and protect the equipment from environmental hazards and unauthorized access. The core of data center 100 may include high-performance servers or compute nodes, often arranged in racks, and connected through high-speed networks. These servers may include processors (e.g., processor 705, CPUs, GPUs, and/or the like), memory (e.g., memory 720, RAM), and storage solutions (e.g., storage 240 and 730, hard disk drives (HDDs), SSDs, and/or the like). The hardware configuration may be optimized for parallel processing and high throughput, catering to the demands of high-performance computing (HPC) applications. Performance of these storage solutions may be improved using embodiments of a method for improving performance of a storage system, according to embodiments of the invention.

The data center 100 may include high-speed network equipment, such as network switches (e.g., Ethernet switches), routers, firewalls, and/or the like to facilitate fast and secure data transmission within data center 100 (e.g., between the servers or compute nodes) and between external networks. Data center 100 may facilitate communication between servers or compute nodes through a network topology that ensures efficient data exchange, minimizes latency, and maximizes bandwidth. The network topology may define how various network devices, such as switches and routers, are interconnected for data flow. By implementing an effective network topology, data center 100 can support high-performance computing tasks. Examples of various network topologies may include hierarchical networking topologies such as the fat tree topology, Slim Fly topology, Dragonfly topology, and/or the like. In at least one example embodiment, Data center 100 corresponds to a collection of network devices, such as network switches (e.g., Ethernet switches) connected with a collection of servers or compute nodes. Data center 100 may adhere to a networking topology (e.g., a hierarchal networking topology), such as a fat tree topology, a Slim Fly topology, a Dragonfly topology, and/or the like. Data center 100 may route traffic among the network switches and servers therein, and at least one layer of the topology in data center 100 is coupled to communication network 540 to allow networking traffic to flow between data center 100 and the network device(s) 512.

Communication network 540 may connect data center 100 to network device(s) 512 and other external devices for data exchange and connectivity. Examples of communication network 540 that may be used to connect data center 100 and the network device(s) 512 include an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like. In one specific but non-limiting example, communication network 540 is a network that enables data transmission between devices 1512 using data signals (e.g., digital, optical, wireless signals).

Each type of network offers specific advantages tailored to different operational requirements. For instance, an IP network or Ethernet network may provide widespread compatibility and case of integration, supporting various protocols and applications across data center 100 and the network device(s) 512 (and/or external devices). An InfiniBand network may offer high throughput and low latency, ideal for HPC environments where rapid data transfer and minimal delay are required. Fibre Channel networks may be employed for their robust performance in storage area networks (SANs), ensuring fast and reliable access to storage resources. Cellular and wireless communication networks may be used to extend connectivity to remote or mobile devices for increased flexibility and accessibility. The ability of communication network 540 to incorporate multiple network types and configurations allows data center 100 to adapt to diverse application needs, from general data communication to specialized HPC tasks. Examples of communication network 540 that may be used to connect data center 100 and the network device(s) 512 include an Internet Protocol (IP) network, an Ethernet network, an InfiniBand (TB) network, a Fibre Channel network, the Internet, a cellular communication network, a wireless communication network, combinations thereof (e.g., Fibre Channel over Ethernet), variants thereof, and/or the like.

Network device(s) 512 may include a variety of computing devices capable of sending and receiving signals over communication network 540. Network device(s) 512 can range from personal computing devices to complex server configurations. Examples include Personal Computers (PCs), laptops, tablets, smartphones, and servers. Network device(s) 512 may facilitate user interactions with data center 100, allowing for data input, retrieval, and processing from remote locations. In addition to individual computing devices, the network device(s) 512 may also include collections of servers or additional data centers. For instance, these could be other data centers similar to or the same as data center 100. Such an interconnection may allow for the formation of a distributed computing environment for improved redundancy, load balancing, and disaster recovery capabilities. By linking multiple data centers, the data center environment 700 can leverage geographically dispersed resources, optimizing performance and ensuring high availability.

One or more network devices 112 may include one or more of Personal Computer (PC), a laptop, a tablet, a smartphone, a server, a collection of servers, and/or any suitable computing device for sending and receiving signals over communication network 540. In at least one example embodiment, one or more network devices 112 correspond to another data center, similar to or the same as data center 100.

As noted above, data center 100 and/or network device(s) 512 may include storage devices and/or processing circuitry for carrying out computing tasks, for example, tasks associated with controlling the flow of data internally and/or over communication network 540. Such processing circuitry may comprise software, hardware, or a combination thereof. For example, the processing circuitry may include a memory (e.g., memory 720) including executable instructions and a processor (e.g., processor 705, a microprocessor) that executes the instructions on the memory. The memory may correspond to any suitable type of memory device or collection of memory devices configured to store instructions. Non-limiting examples of suitable memory devices that may be used include Flash memory, RAM, ROM, variants thereof, combinations thereof, or the like. In some embodiments, the memory and processor may be integrated into a common device (e.g., a microprocessor may include integrated memory). Additionally or alternatively, the processing circuitry may comprise hardware, such as an application specific integrated circuit (ASIC). Other non-limiting examples of the processing circuitry include an Integrated Circuit (IC) chip, a CPU, GPU, a microprocessor, a Field Programmable Gate Array (FPGA), a collection of logic gates or transistors, resistors, capacitors, inductors, diodes, or the like. Some or all of the processing circuitry may be provided on a Printed Circuit Board (PCB) or collection of PCBs. It should be appreciated that any appropriate type of electrical component or collection of electrical components may be suitable for inclusion in the processing circuitry.

In addition, although not explicitly shown, it should be appreciated that data center 100 and network device(s) 512 may include one or more communication interfaces for facilitating wired and/or wireless communication between one another and other unillustrated elements of the data center environment 500. These communication interfaces may include a variety of technologies, including but not limited to Ethernet ports, fiber optic connections, Wi-Fi® transceivers, Bluetooth® modules, and cellular communication modules for integration and interoperability among the various components within the data center environment 700. Furthermore, it should be understood that the data center environment 500 may include additional components and functionalities within the scope of the present disclosure. These components may comprise, without limitation, additional processing units, specialized accelerators (such as Tensor Processing Units or TPUs), enhanced security modules, and redundant power supplies. The inclusion of these elements is intended to ensure that the data center environment 700 is robust, scalable, and capable of meeting diverse operational requirements. Any variations, modifications, or adaptations of the described elements that fall within the spirit and scope of the disclosure are considered to be encompassed by the present disclosure. This includes any combinations, sub-combinations, or enhancements of the various described elements to achieve improved performance, reliability, and efficiency in the data center environment 500.

FIG. 6 illustrates an example data center 100, in which at least one embodiment may be used. Data center 100 may include one or more rooms having racks 102 and auxiliary equipment used to house one or more racks 102 and one or more baseboards 104. Rack 102 can include one or more baseboards 104. Rack 102 can include a housing that receives and supports individual baseboards 104. Operational aspects of rack 102 may be regulated at a rack level, corresponding to a group of baseboards 104, or at a baseboard level, corresponding to individual baseboards 104, among other options. Rack 102 or baseboards 104 can have particularly selected maximum operating parameters, such as, but not limited to, power consumption, operating frequencies, and others. Data center 100 can be supported by various cooling systems, such as, but not limited to, cooling towers, cooling loops, pumps, and other support systems. Cooling systems may include sensors and controllers to monitor and managing cooling properties for racks 102. Baseboards 104 within racks 102 can get operational power from one or more power distribution units (PDUs; not shown). PDUs may be arranged within racks 102, for example between racks 102 including baseboards 104, or within racks 102 that also house baseboards 104.

Racks 102 and baseboards 104 can include sub-systems, modules, add-in cards, and other semiconductor components. Baseboards 104 can include one or more computing units 106 that can include one or more processors 108, one or more memory 110, and an interface controller 112. Computing units 106 may include any number of processors, such as, but not limited to, CPUs, GPUs, or other processors (including accelerators, field programmable gate arrays (FPGAs), graphics processors, etc.), including any processors described herein, such as, but not limited to, the processor 705. Computing units 106 can include one or more memory storage devices 110 (e.g., storage 240 and 730, dynamic read-only memory, solid state storage or disk drives), as well as network input/output (“NW I/O”) devices, network switches, virtual machines (“VMs”), power modules, and cooling modules, etc. One or more computing units 106 may be a server having one or more of above-mentioned computing resources.

Computing units 106 can include separate groupings of computing units housed within one or more racks (not shown), or many racks housed in data centers at various geographical locations (also not shown). Separate groupings of computing units may include grouped compute, network, memory or storage resources that may be configured or allocated to support one or more workloads. Several computing units (e.g., including CPUs and/or other processors) may be grouped within one or more racks 102 to provide compute resources to support one or more workloads. A resource orchestrator 114 may configure or otherwise control one or more computing units 106 or groups of computing units. Resource orchestrator 114 may include a software design infrastructure (“SDI”) management entity for data center 100. Resource orchestrator 114 may include hardware, software or some combination thereof.

Data center 100 can include any one of or any combination of a framework layer 120, a software layer 130 and an application layer 6340. As shown in FIG. 6, framework layer 120 includes a job scheduler 122, a configuration manager 124, a resource manager 1126 and a distributed file system 128. Framework layer 120 may include a framework to support software 132 of software layer 130 and/or one or more application(s) 142 of application layer 140. Software 132 or application(s) 142 may respectively include web-based service software or applications, such as, but not limited to, those provided by Amazon Web Services, Google Cloud and Microsoft Azure. Framework layer 120 may be a type of free and open-source software web application framework such as, but not limited to, Apache Spark™ (hereinafter “Spark”) that may utilize distributed file system 128 for large-scale data processing (e.g., “big data”). Job scheduler 122 may include a Spark driver to facilitate scheduling of workloads supported by various layers of data center 100. Configuration manager 124 may be capable of configuring different layers such as, but not limited to, software layer 130 and framework layer 120 including Spark and distributed file system 128 for supporting large-scale data processing. Resource manager 1126 may be capable of managing clustered or grouped computing units 106 mapped to or allocated for support of distributed file system 128 and job scheduler 122. Resource manager 1126 may coordinate with resource orchestrator 114 to manage these mapped or allocated computing resources.

Software 132 can be included in software layer 130 and may include software used by at least portions of a computing unit 106, one or more computing units 106, groups of computing units 106, and/or distributed file system 128 of framework layer 120. One or more types of software may include, but are not limited to, Internet web page search software, e-mail virus scan software, database software, and streaming video content software.

Application(s) 142 can be included in application layer 140 and may include one or more types of applications used by at least portions of a computing unit 106, one or more computing units 106, groups of computing units 106, and/or distributed file system 128 of framework layer 120. One or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

Any of configuration manager 124, resource manager 1126, and resource orchestrator 114 may implement any number and type of self-modifying actions based on any amount and type of data acquired in any technically feasible fashion. Self-modifying actions may relieve a data center operator of data center 100 from making possibly bad configuration decisions and possibly avoiding underutilized and/or poor performing portions of a data center.

Data center 100 may include tools, services, software or other resources to train one or more machine learning models or predict or infer information using one or more machine learning models in accordance with one or more embodiments described herein. For example, a machine learning model may be trained by calculating weight parameters in accordance with a neural network architecture using software and computing resources described above with respect to data center 100. Trained machine learning models corresponding to one or more neural networks may be used to infer or predict information using resources described above with respect to data center 100 by using weight parameters calculated through one or more training techniques described herein.

Data center 100 may use CPUs, application-specific integrated circuits (ASICs), GPUs, FPGAs, or other hardware (e.g., processor 705) to perform some or all of processes and techniques described elsewhere herein, such as, but not limited to, training and/or inferencing using above-described resources. Moreover, one or more software and/or hardware resources described above may be configured as a service to allow users to train or performing inferencing of information, such as, but not limited to, image recognition, speech recognition, or other artificial intelligence services.

In at least one embodiment, processor 108 can include one of processors 705 and/or comprises one or more circuits such as storage driver 710 or 210 to improve performance of a storage system 240, 110 or 730 by measuring at least one performance indicator of storage system 240, 110 or 730, while performing input and/or output operations to storage system 240 or 730, changing a plurality of configuration parameters of storage system 240, 110 or 730 using an optimization scheme, and repeating changing and measuring until a stopping criterion is met, or otherwise perform any of the operations described above or elsewhere herein. In at least one embodiment, processor 108 is configured by software 132 to improve performance of a storage system 240, 110 or 730 by measuring at least one performance indicator of storage system 240, 110 or 730, while performing input and/or output operations to storage system 240 or 730, changing a plurality of configuration parameters of storage system 240, 110 or 730 using an optimization scheme, and repeating changing and measuring until a stopping criterion is met, or otherwise perform any of the operations described above or elsewhere herein. Data center 100 may use logic, CPUs, application-specific integrated circuits (ASICs), GPUs, FPGAs, or other hardware (e.g., processor 705) to perform any of the operations described above or elsewhere herein.

One skilled in the art will realize the invention may be embodied in other specific forms using other details without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein. In some cases well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” can include, for example, “multiple” or “two or more”. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A method for improving performance of a storage system, the method comprising, using a computer processor:
measuring at least one performance indicator of the storage system, while performing input and/or output operations to the storage system;
using an optimization scheme, changing a plurality of configuration parameters of the storage system; and
repeating changing and measuring until a stopping criterion is met.

2. The method of claim 1, wherein the optimization scheme is Bayesian optimization.

3. The method of claim 1, wherein the optimization scheme is reinforcement learning.

4. The method of claim 1, wherein the storage system comprises:
at least one remote storage system; and
an emulator connected to a host and to the remote storage system, wherein the emulator is configured to emulate the remote storage system to appear as a local disk to the host.

5. The method of claim 4, wherein each of the plurality of configuration parameters is selected from the list consisting of: a block size, a number of the remote storage systems and speed of the remote storage systems.

6. The method of claim 1, wherein each of the at least one performance indicator is selected from the list consisting of: input and output operations speed, a measure of fairness, latency and throughput.

7. The method of claim 1, wherein the stopping criterion is that the at least one performance indicator reach a steady state.

8. The method of claim 1, wherein the stopping criterion is that a predetermined number of iterations have been performed.

9. The method of claim 1, wherein the storage system is implemented in a data center.

10. A system for improving performance of a storage system, the system comprising:
a memory; and
a processor to:
measure at least one performance indicator of the storage system, while performing input and/or output operations to the storage system;
use an optimization scheme, changing a plurality of configuration parameters of the storage system; and
repeat changing and measuring until a stopping criterion is met.

11. The system of claim 10, wherein the optimization scheme is Bayesian optimization.

12. The system of claim 10, wherein the optimization scheme is reinforcement learning.

13. The system of claim 10, wherein the storage system comprises at least one remote storage system, and wherein the processor to emulate the remote storage system to appear as a local disk.

14. The system of claim 13, wherein each of the plurality of configuration parameters is selected from the list consisting of: a block size, a number of the remote storage systems and speed of the remote storage systems.

15. The system of claim 10, wherein each of the at least one performance indicator is selected from the list consisting of: input and output operations speed, a measure of fairness, latency and throughput.

16. The system of claim 10, wherein the stopping criterion is that the at least one performance indicator reach a steady state.

17. The system of claim 10, wherein the stopping criterion is that a predetermined number of iterations have been performed.

18. The system of claim 10, wherein the memory, processor and storage system are implemented in a data center.
